(19) United States
(12) Patent Application Publication
(10) Pub. No.: US 2011/0232000 A1
(43) Pub. Date: Sep. 29, 2011

(54) LOO LOO BEE SYSTEM

(76) Inventors: Vitmary Rodriguez, Oxon Hill, MD (US); Lance Edwards, Oxon Hill, MD (US)

(21) Appl. No.: 13/071,315

(22) Filed: Mar. 24, 2011

Related U.S. Application Data
(60) Provisional application No. 61/318,293, filed on Mar. 27, 2010.

(51) Int. Cl. B62B 9/00; A47D 13/00; B62B 7/00

(52) U.S. Cl. 5/655

(57) ABSTRACT

An attachable diaper-changing table for use with a stroller and/or other suitable sturdy surface(s) such as a bathroom counter or bench. The attachable diaper-changing table enables a caregiver to easily and safely change a diaper of an infant along with providing a clean, elevated and sanitary surface on which to change a soiled diaper while on the go. The attachable diaper-changing table comprises a removably-attachable changing table platform assembly and adjustable support brackets.

### CROSS-REFERENCE TO RELATED APPLICATION

The present application is related to and claims priority from prior provisional application Ser. No. 61/318,293, filed Mar. 27, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of change tables and more specifically relates to portable change tables for use with strollers and other sturdy surfaces.

2. Description of the Related Art

The anticipated arrival of a new baby is a joyous time for most couples. As the expectant mother's belly swells, an expectant father might help out by transforming his den or office into a newly decorated nursery. As diapers, bottles and other accessories are purchased, birthing classes are attended and books are read. The coming birth is made all the more meaningful with each passing day. Friends, grandparents-to-be and other family members give thoughtful advice to the expectant parents and baby showers are thrown honoring the blessed event. Although the birth or adoption of a baby is a joyous time, nothing can fully prepare parents for the hard work involved once the baby is actually born.

While the joys of parenting have never been disputed, there is one task in regards to a child's upbringing which can sometimes be challenging. Specifically, the necessary chore of changing a child's diaper can be a difficult endeavor when spending time away from home. While many public restroom facilities have changing tables on the premises, these devices can be extremely unsanitary, often sprinkled with waste matter, germs and bacteria left behind by previous users. As such, most conscientious mothers and/or fathers may think twice before placing their infant on one of these tables thereby exposing them to this harmful matter. Unfortunately, failing to change a child's diaper when needed may cause discomfort to the child and, if left unattended for too long can result in painful diaper rash and other maladies.

Strollers are used by many individuals to provide transport for infants and small children. Many times children being transported in strollers need their diapers to be changed during these periods and the caregiver must find a suitable place in which to change the child's diaper. This may create inconvenience for the child and caregiver.

Various attempts have been made to solve problems found in change table art. Among these are found in: U.S. Pat. No. 6,389,624 to Madole; U.S. Pat. No. 3,101,970 to Karmel; and U.S. Pat. No. 7,618,055 to Chuah. This prior art is representative of change tables.

None of the above inventions and patents, taken either singly or in combination, is seen to describe the invention as claimed. Thus, a need exists for a stroller with a removable change table to avoid the above-mentioned problems.

### BRIEF SUMMARY OF THE INVENTION

In view of the foregoing disadvantages inherent in the known change table art, the present invention provides a novel stroller with detachable change table. The general purpose of the present invention, which will be described subsequently in greater detail, is to provide a portable change table for use with a stroller and other sturdy surfaces. The features of the invention which are believed to be novel are particularly pointed out and distinctly claimed in the concluding portion of the specification. These and other features, aspects, and advantages of the present invention will become better understood with reference to the following drawings and detailed description.

The present attachable diaper-changing table system in a first embodiment as disclosed herein comprises: a removably-attachable changing table platform assembly; at least two adjustable support brackets; at least one adjustable restrainer; and telescopic legs.

In this particular embodiment the removably-attachable changing table platform assembly is vertically-rotationally-stored behind a seat of a stroller and is manipulatable between the vertically-rotationally-stored and horizontally-deployed positions by rotating the removably-attachable changing table platform assembly about the adjustable support brackets and telescopically-extending removably-attachable changing table platform assembly outwardly from behind the seat of the stroller to create an in-use condition. Further, the removably-attachable changing table platform assembly is foldably-storable and comprises a baby-sized cot having a telescoping cloth cover portion and a reinforced canvas canopy in certain versions of the present invention. Also, the removably-attachable changing table platform assembly is manipulatable for attachment to a stationary object in other embodiments.

The telescoping legs may include safety locks along with nonskid rubber feet. Also, the telescopic legs are inwardly and outwardly foldable and may preferably comprise aluminum to feature lightweight characteristics. The adjustable restrainers may comprise at least one safety belt for securing a baby to the removably-attachable changing table platform assembly. The two adjustable support brackets located on the stroller are used for linking the removably-attachable changing table platform assembly to the stroller or other sturdy planar surface such as a bathroom counter or bench.

A kit is embodied herein for the Loo Loo Bee system comprising: a removably-attachable changing table platform assembly; adjustable support brackets; a pair of telescoping legs; a stroller; and a set of user instructions.

In accordance with the embodiments of the present invention a preferred method of use is disclosed herein comprising: securing removably-attachable changing the table platform assembly to a sturdy planar surface; securing the infant; changing the infant; unsecuring the infant; and un-securing the two adjustable support brackets on the removably-attachable changing table platform assembly thereby removing the removably-attachable changing table platform assembly from the sturdy planar surface. (Method for use with alternate embodiment.)

An alternate method of use comprises the steps of: securing removably-attachable changing table platform assembly behind a seat of the stroller; retrieving the removably-attachable changing table platform assembly from a vertically-rotationally-stored position behind the seat of the stroller; positioning removably-attachable changing table platform assembly such that the removably-attachable changing table platform assembly is in a horizontally-deployed position relative to the seat of the stroller; extending telescoping legs of the removably-attachable changing table platform assembly so that the telescoping legs bridge the distance between the removably-attachable changing table platform assembly and the substantially flat (planar) surface below; locking the telescoping legs in place; laying an infant directly on a sanitary surface of the removably-attachable changing table platform assembly; securing the adjustable safety belts about the infant; changing the infant; unsecuring the infant; and returning the removably-attachable changing table platform assembly to the vertically-rotationally-stored position against the seat of said stroller. (Method for use with first embodiment mentioned herein.)

The present invention holds significant improvements and serves as a Loo Loo Bee system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Loo loo bee system, constructed and operative according to the teachings of the present invention.

FIG. 1 shows a perspective view illustrating a stroller attached diaper-changing table system in an ‘in-use’ position according to an embodiment of the present invention.

FIG. 2 is a perspective view illustrating a removably-attachable changing table platform assembly being retracted according to an embodiment of the present invention.

FIG. 3 is a perspective view illustrating the removably-attachable changing table platform assembly in an unattached position according to an embodiment of the present invention.

FIG. 4 is a perspective view illustrating the removably-attachable changing table platform assembly being further retracted according to an embodiment of the present invention.

FIG. 5A is a perspective view illustrating a safety belt on the removably-attachable changing table platform assembly in an un-secured position.

FIG. 5B is a perspective view illustrating a safety belt on the removably-attachable changing table platform assembly in a secured position.

FIG. 6 is a perspective view illustrating the removably-attachable changing table platform assembly being removeably-coupleable to a sturdy planar surface.

FIG. 7 is a perspective view illustrating the removably-attachable changing table platform assembly being folded into a portable bag according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to change tables and more specifically relates to Loo Loo Bee system 100 for use with strollers and other sturdy surfaces as used to improve the convenience for a caregiver to change an infant's diaper when away from home.

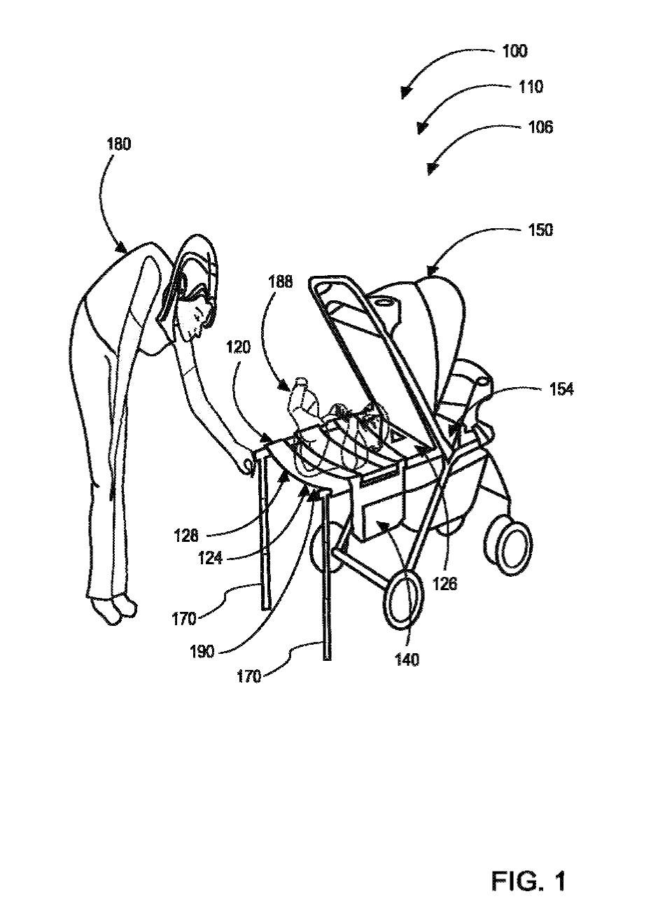

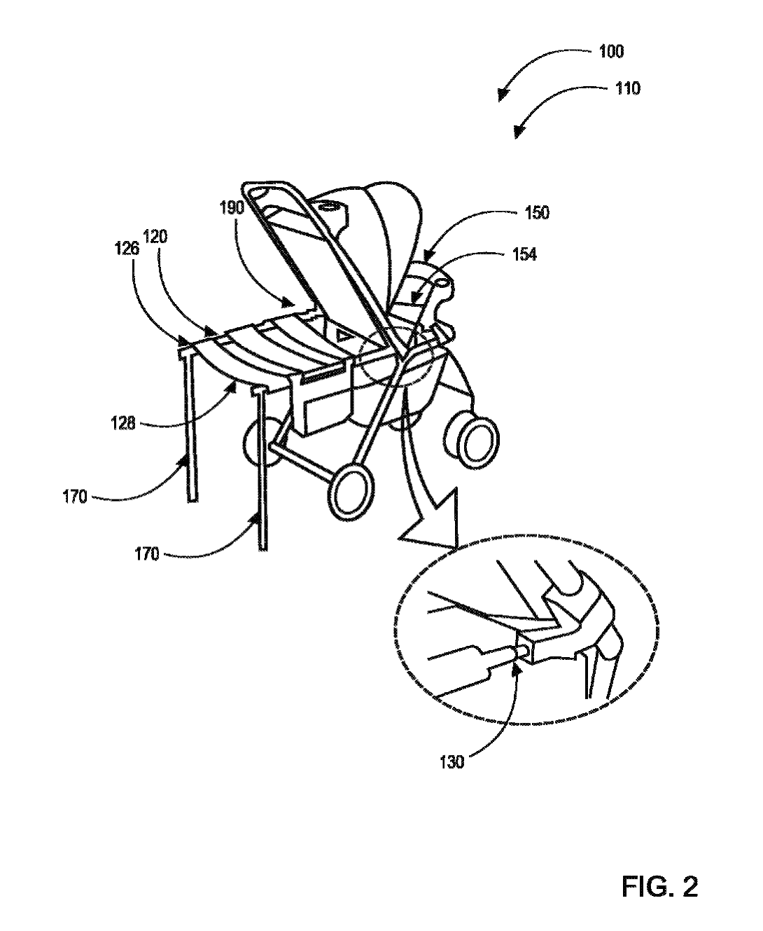

Referring now to FIG. 1-4 showing perspective views of Loo Loo Bee system 100 according to an embodiment of the present invention. Loo Loo Bee system 100 enables caregiver 180 to easily and safely change a diaper of infant 188 along with providing a clean, elevated and sanitary surface on which to change a diaper when ‘on-the-go’ as shown in ‘in-use’ condition 106 in FIG. 1. Loo Loo Bee system 100 preferably comprises stroller attached diaper-changing table 110. Stroller attached diaper-changing table 110 may be removably-attachable to stroller 150. It should be noted that stroller attached diaper-changing table 110 may be removably-attachable to other flat planar surfaces as shown and discussed in FIG. 6. Therefore, stroller attached diaper-changing table 110 preferably eliminates the need to use public changing stations which can be rife with germs and bacteria. In this way the present invention promotes good health of infant 188 and caregiver(s) 180.

Stroller attached diaper-changing table 110 is preferably manufactured from rigid, light weight, preferably aluminum or plastic material, however other suitable lightweight, durable materials may be used. Stroller attached diaper-changing table 110 preferably includes removably-attachable changing table platform assembly 120 and at least two adjustable support brackets 130. Adjustable support brackets 130 are preferably located on stroller 150 for linking removably-attachable changing table platform assembly 120 to stroller 150. More specifically, adjustable support brackets 130 may be positioned on either side on a posterior region of stroller attached diaper-changing table 110.

Removably-attachable changing table platform assembly 120 has an approximate 40 pound weight capacity and is preferably vertically-rotationally-stored behind seat 154 of stroller 150 as shown best in FIG. 4. Further, removably-attachable changing table platform assembly 120 may be manipulatable between vertically-rotationally-stored position 400 (as alluded to in FIG. 4) and horizontally-deployed position 190 (as alluded to in FIG. 1). This rotation from vertically-rotationally-stored position 400 to horizontally-deployed position 190 and vice versa may be done by rotating removably-attachable changing table platform assembly 120 about adjustable support brackets 130 and telescopically-extending removably-attachable changing table platform assembly 120 outwardly from behind seat 154 of stroller 150 during an ‘in-use’ condition 106 such that infant 188 may be suitably supported and changed on removably-attachable changing table platform assembly 120.

Removably-attachable changing table platform assembly 120 further comprises canopy 124 in certain embodiments. Canopy 124 may comprise reinforced canvas. Upon reading this specification, it should be appreciated that, under appropriate circumstances, considering such issues as user preferences, design preference, structural requirements, marketing preferences, cost, available materials, technological advances, etc., other materials such as, for example, cloth, fabric, cotton, etc., may be sufficient. Removably-attachable changing table platform assembly 120 further comprises baby-sized cot 126. Baby-sized cot 126 includes telescoping cloth cover portion 128 and is formed when canopy 124 is preferably stretched over removably-attachable changing table platform assembly 120 thereby forming stroller attached diaper-changing table 110. Also, canopy 124 may be double stitched and reinforced for added strength and durability when supporting infant 188.

Telescoping cloth cover portion 128 of stroller attached diaper-changing table 110 may be machine washable and may be produced in a variety of colors, as well as a host of patterns or printed designs. Due to the safety and well being of infant 188 being of utmost concern, stroller attached diaper-changing table 110 may preferably be manufactured in accordance to the stringent guidelines for children's products as set forth by the Juvenile Products Manufactures Association (JPMA).

Providing support and stability to stroller attached diaper-changing table 110 are two telescopic legs 170. Telescopic legs 170 are preferably positioned on a front end on either side of stroller attached diaper-changing table 110 to bridge the distance from stroller attached diaper-changing table 110 to a flat surface below such as a ground surface. Telescopic legs 170 may further comprise non-skid rubber feet 174 and safety locks to increase safety for infant 188 while on removably-attachable changing table platform assembly 120 by limiting the range of motion of stroller attached diaper-changing table 110. Telescopic legs 170 may also be inwardly and outwardly foldable and comprise aluminum. Upon reading this specification, it should be appreciated that, under appropriate circumstances, considering such issues as user preferences, design preference, structural requirements, marketing preferences, cost, available materials, technological advances, etc., other materials for telescopic legs such as, for example, other metals, alloys, plastics etc., may be sufficient.

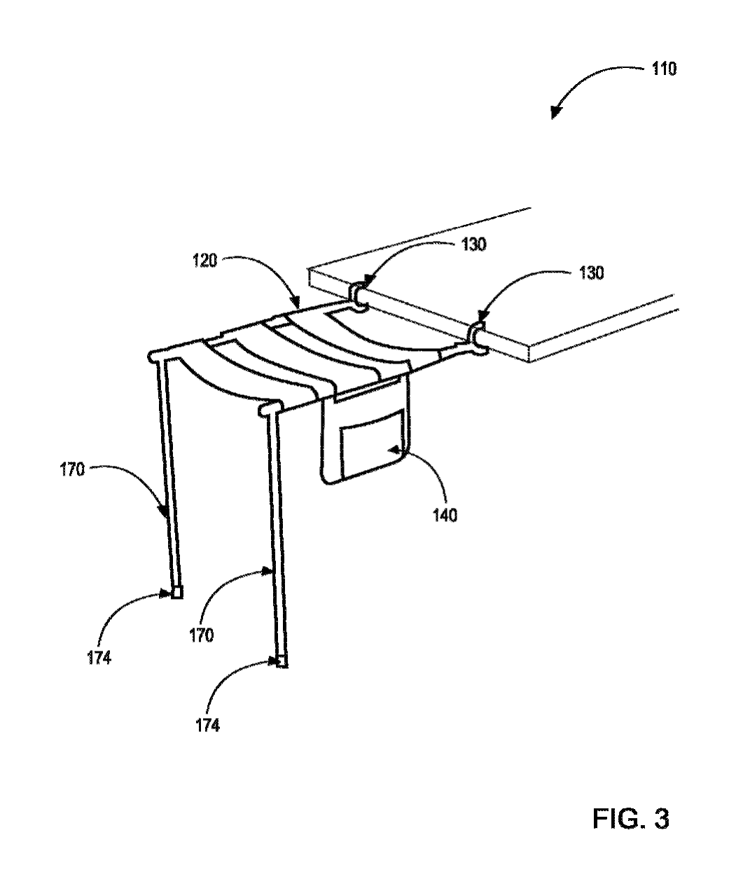

Removably-attachable changing table platform assembly 120 may also comprise diaper depot 140 as shown best in FIG. 3. Diaper depot 140 preferably comprises a bag that is removably-attachable to removably-attachable changing table platform assembly 120 or another flat planar surface for easily dispensing and holding extra diapers, lotions, creams, and accessories for infant 188.

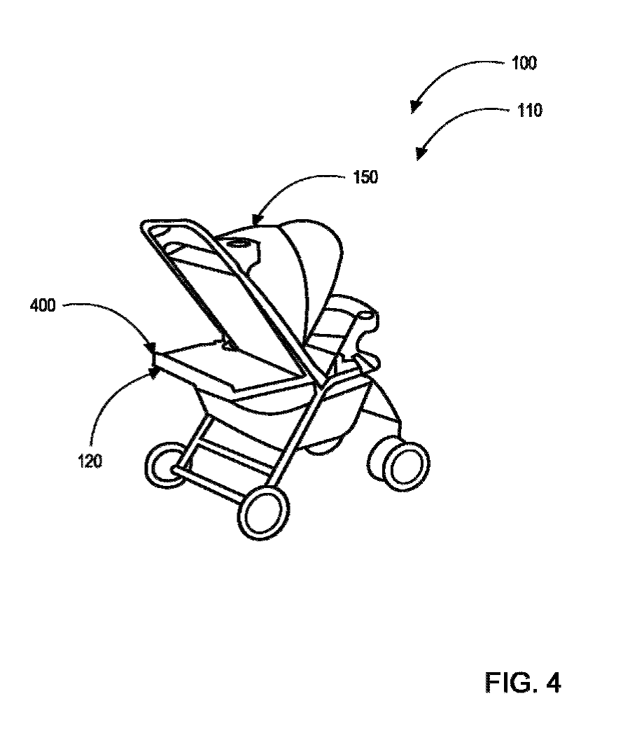

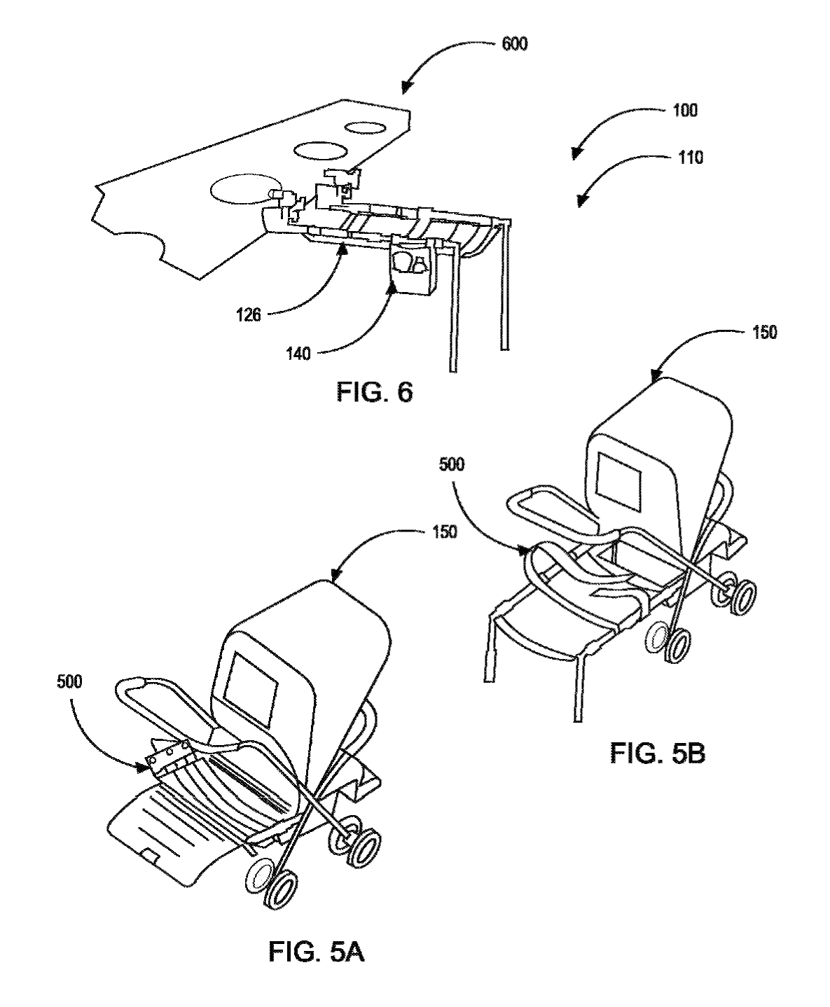

Referring now to FIGS. 5A & 5B showing perspective views illustrating safety belt(s) 500 on removably-attachable changing table platform assembly 120. Removably-attachable changing table platform assembly 120 comprises at least one safety belt(s) 500 that may run horizontally across a surface of removably-attachable changing table platform assembly 120 thus enabling caregiver 180 to safely restrain infant 188 while ‘in-use’ condition 106. Safety belt(s) 500 acts as a restrainer to prevent movement/motion of infant 188 and is/are preferably adjustable.

Referring now to FIG. 6, showing a perspective view illustrating removably-attachable changing table platform assembly 120 removeable coupleable to sturdy planar surface 600. When caregiver 180 is not using stroller 150 to transport infant 188, stroller attached diaper-changing table 110 may be removeably-coupleable to sturdy planar surface 600 to change a diaper of infant 188. Sturdy planar surface 600 may comprise but is not limited to any flat surface such as a bathroom counter, a park bench, a table, etc. To removably-attach removably-attachable changing table platform assembly 120 to sturdy planar surface 600 adjustable support brackets 130 are secured to sturdy planar surface 600 prior to use. Once a ‘used’ diaper of infant 188 is removed and changed, infant 188 may be unsecured. Then adjustable support brackets 130 are un-secured thereby removing the removably-attachable changing table platform assembly 120 from the sturdy planar surface 600.

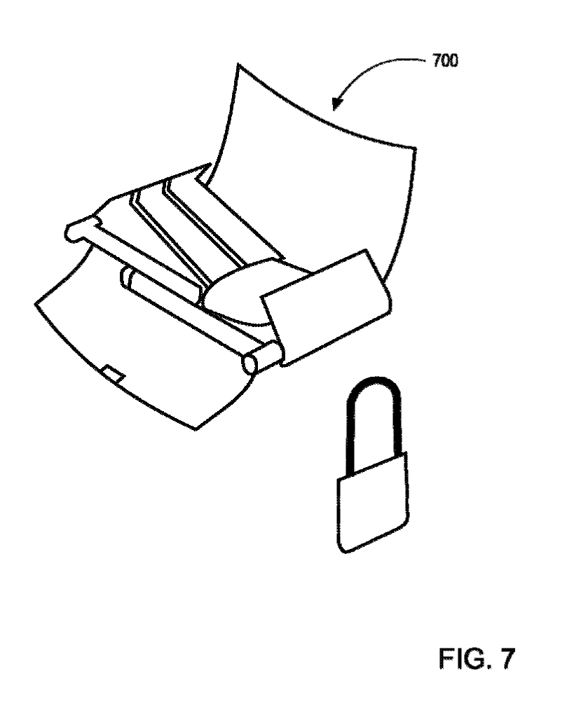

Referring now to FIG. 7, showing is a perspective view illustrating removably-attachable changing table platform assembly 120 being folded into portable bag 700 according to an embodiment of the present invention. Portable bag 700 is preferably used when caregiver 180 is not using stroller 150 and/or prefers to use removably-attachable changing table platform assembly 120 on sturdy planar surface 600. Removably-attachable changing table platform assembly 120 may be temporarily stored in a folded condition in portable bag 700 when not in use. When needed, removably-attachable changing table platform assembly 120 may be un-folded and secured to sturdy planar surface 600.

Loo Loo Bee system 100 according to an embodiment of the present invention of FIGS. 1-4 may comprise kit 740. Kit 740 may comprise the following parts: removably-attachable changing table platform assembly 120; adjustable support brackets 130; pair of telescoping legs 170; stroller 150; and a set of user instructions. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately.

A method of using an attachable diaper-changing table system may comprise the steps of: step one securing two adjustable support brackets 130 located on removably-attachable changing table platform assembly 120 to sturdy planar surface 600 prior to use; step two changing a diaper of infant 188; step three unsecuring infant 188; step four un-securing two adjustable support brackets 130 on removably-attachable changing table platform assembly 120 thereby removing removably-attachable changing table platform assembly 120 from sturdy planar surface 600. In this way the present invention may serve as a multi-purpose device.

An alternate method of use may comprise the steps of: step one securing removably-attachable changing table platform assembly 120 behind seat 154 of stroller 150; step two retrieving removably-attachable changing table platform assembly 120 from vertically-rotationally-stored position 400 behind seat 154 of stroller 150; step three positioning removably-attachable changing table platform assembly 120 such that removably-attachable changing table platform assembly 120 is in horizontally-deployed position 190 relative to seat 154 of stroller 150; step four extending telescoping legs 170 of removably-attachable changing table platform assembly 120 so that telescoping legs 170 bridge the distance between removably-attachable changing table platform assembly 120 and the flat surface below; step five locking telescoping legs 170 in place; step six laying infant 188 directly on a sanitary surface of removably-attachable changing table platform assembly 120; step seven securing adjustable safety belt(s) 500 about infant 188; step eight changing a diaper of infant 188; step nine unsecuring infant 188; and step ten returning removably-attachable changing table platform assembly 120 to vertically-rotationally-stored position 400 against seat 154 of stroller 150.

It should be noted that the steps described in the methods of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A stroller attached diaper-changing table system comprising:
a removably-attachable changing table platform assembly; and
at least two adjustable support brackets located on said stroller for linking said removably-attachable changing table platform assembly to said stroller;
wherein said removably-attachable changing table platform assembly is vertically-rotationally-stored behind a seat of said stroller; and
wherein said removably-attachable changing table platform assembly is manipulatable between said vertically-rotationally-stored and horizontally-deployed positions by rotating said removably-attachable changing table platform assembly about said adjustable support brackets and telescopically-extending removably-attachable changing table platform assembly outwardly from behind said seat of said stroller during an in-use condition.

2. The stroller attached diaper-changing table system of claim 1 further comprising at least one adjustable restrainer.

3. The stroller attached diaper-changing table system of claim 2 wherein said adjustable restrainers comprises at least one safety belt.

4. The stroller attached diaper-changing table system of claim 1 wherein said removably-attachable changing table platform assembly comprises legs.

5. The stroller attached diaper-changing table system of claim 4 wherein said legs are telescopic.

6. The stroller attached diaper-changing table system of claim 4 wherein said legs comprise non-skid rubber feet.

7. The stroller attached diaper-changing table system of claim 5 wherein said telescopic legs comprise safety locks.

8. The stroller attached diaper-changing table system of claim 1 wherein said removably-attachable changing table platform assembly further comprises a canopy.

9. The stroller attached diaper-changing table system of claim 8 wherein said canopy is reinforced canvas.

10. The stroller attached diaper-changing table system of claim 1 wherein said removably-attachable changing table platform assembly comprises a baby-sized cot.

11. The stroller attached diaper-changing table system of claim 10 wherein said removably-attachable changing table platform further comprises a telescoping cloth cover portion.

12. The stroller attached diaper-changing table system of claim 7 wherein said telescopic legs are inwardly and outwardly foldable.

13. The stroller attached diaper-changing table system of claim 12 wherein said telescopic legs comprise aluminum.

14. The stroller attached diaper-changing table system of claim 1 wherein said removably-attachable changing table platform assembly is removeable coupleable to a sturdy planar surface.

15. The stroller attached diaper-changing table system of claim 1 wherein said sturdy planar surface comprises a bathroom counter.

16. The stroller attached diaper-changing table system of claim 1 wherein said sturdy planar surface comprises a bench.

17. An attachable diaper-changing table system comprising:
a removably-attachable changing table platform assembly;
at least two adjustable support brackets located on said removably-attachable changing table platform for linking said removably-attachable changing table platform assembly to a stationary object;
at least one adjustable restrainer; and
inwardly and outwardly foldable aluminum telescopic legs;
wherein said removably-attachable changing table platform assembly comprises a baby-sized cot having a telescoping cloth cover portion and a reinforced canvas canopy, and is foldably-storable;
wherein said removably-attachable changing table platform assembly is manipulatable for attachment to said stationary object;
wherein said telescoping legs have safety locks, nonskid rubber feet; and
wherein said adjustable restrainers comprises at least one safety belt for securing a baby to said removably-attachable changing table platform assembly.

18. The attachable diaper-changing table system of claim 17 further comprising a kit including: said removably-attachable changing table platform assembly; said stroller; said reinforced canvas canopy; and a set of user instructions.

19. A method of using an attachable diaper-changing table system comprising the steps of:
securing a removably-attachable changing table platform assembly to a sturdy planar surface;
securing an infant;
changing said infant;
unsecuring said infant; and
un-securing two adjustable support brackets on said removably-attachable changing table platform assembly thereby removing said removably-attachable changing table platform assembly from said sturdy planar surface.

20. The method of using an attachable diaper-changing table system of claim 19 further comprising the steps of:
securing a removably-attachable changing table platform assembly to said sturdy planar surface, wherein said sturdy planar surface comprises a frame of a stroller with a seat;
rotating the removably-attachable changing table platform assembly from a vertically-rotationally-stored position behind said seat of said stroller;
positioning removably-attachable changing table platform assembly such that said removably-attachable changing table platform assembly is in a horizontally-deployed position relative to said seat of said stroller;
extending telescoping legs of said removably-attachable changing table platform assembly such that said telescoping legs bridge the distance between said removably-attachable changing table platform assembly and said flat surface located below;
locking said telescoping legs in place;
laying said infant directly on a sanitary surface of said removably-attachable changing table platform assembly;
securing adjustable safety belts about said infant;
changing said infant;
unsecuring said infant; and
returning said removably-attachable changing table platform assembly to said vertically-rotationally-stored position behind and adjacent said seat of said stroller.
